(19) United States
(12) Patent Application Publication
(10) Pub. No.: US 2005/0184246 A1
(43) Pub. Date: Aug. 25, 2005

(54) Detector module and detector for an X-ray computer tomograph

(76) Inventors: Ludwig Danzer, Wendelstein (DE); Bjoern Heismann, Erlangen (DE); Richard Matz, Bruckmuehl (DE); Heinz Pilz, Berlin (DE); Stefan Wirth, Erlangen (DE); Joerg Zapf, Muenchen (DE)

Correspondence Address: HARNESS, DICKEY & PIERCE, P.L.C., P.O.BOX 8910, RESTON, VA, 20195, US

(21) Appl. No.: 11/053,938

(22) Filed: Feb. 10, 2005

(30) Foreign Application Priority Data
Feb. 10, 2004 (DE) 10 2004 006 549.7
Jul. 1, 2004 (DE) 10 2004 031 985.5

(51) Int. Cl. G01T 1/16

(52) U.S. Cl. 250/370.09

(57) ABSTRACT

A detector module for an X-ray computer tomograph, includes a number of sensor arrays provided next to one another on a printed circuit board. Each of the sensor arrays includes a plurality of first contact elements on a top side, averted from the printed circuit board. In order to make contact with the sensor array, the first contact elements are electrically connected to second contact elements with the aid of conductor tracks that are accommodated in or on an electrically insulating flexible carrier.

The present application hereby claims priority under 35 U.S.C. §119 on German patent application numbers DE 10 2004 006 59.7 filed Feb. 10, 2004 and DE 10 2004 031 985.5 filed Jul. 1, 2004, the entire contents of each of which are hereby incorporated herein by reference.

### FIELD OF THE INVENTION

The invention generally relates to a detector module and/or to a detector for an X-ray computer tomograph.

### BACKGROUND OF THE INVENTION

EP 0 819 406 A1 discloses an X-ray computer tomograph whose detector is constructed from modules. Each module has a printed circuit board on which a number of sensor sub-modules are mounted one behind the other in a z-direction. Each of the sensor sub-modules in turn includes a number of detector elements that are arranged in a row in a φ-direction. Four sensor sub-modules are respectively arranged next to one another in the z-direction in the case of the modules known in accordance with the prior art. The sensor sub-modules make contact with a downstream electronic system via bonded connections provided at the edge.

Success has, in the meantime, been achieved in the further minimization of sensor sub-modules and, at the same time, in combining a multiplicity of detector elements both in the z-direction and in the φ-direction to form a sensor sub-module that is denoted below as a “sensor array”. Because of the slight size of the sensor array, it is possible in the case of a module to arrange a number of sensor arrays both in the z-direction and in the φ-direction in the manner of a chessboard in two dimensions. In order to ensure a highest possible image quality, such sensor arrays must be fitted next to one another while avoiding interspaces as far as possible. This renders it difficult to connect contact elements provided on the top side of the sensor array to a downstream electronic system.

### SUMMARY OF THE INVENTION

It is an object of an embodiment of the invention to overcome the difficulty according to the prior art. In particular, one aim is to specify a detector module with whose sensor arrays contact can be made as simply and cost-effectively as possible.

In accordance with an embodiment of the invention, a detector module for an X-ray tomograph is proposed, in which a number of sensor arrays are provided next to one another on a printed circuit board, each of the sensor arrays having a plurality of first contact elements on a top side averted from the printed circuit board. The first contact elements are connected in an electrically conducting fashion to second contact elements via conductor tracks that are accommodated in or on an electrically insulating, flexible carrier.

The layered structure proposed according to an embodiment of the invention renders it possible to provide electrically conducting connections with a very small thickness. In this way, the first contact elements provided on the top side of the sensor array can be connected to second contact elements simply and cost-effectively.

For this purpose, the conductor tracks may only be passed through between the rims of two neighboring sensor arrays. The conductor tracks may be expediently accommodated on the carrier and covered by an insulation. The carrier can be in the form of a thin film that enables a closely neighboring horizontal arrangement of the sensor arrays, the film being used to pass the conductor tracks through vertically from the first contact elements to the second contact elements.

According to an advantageous refinement, the first contact elements may be provided at the edge of the sensor array. The second contact elements can be provided on a side opposite the top side. The first and/or second contact elements may be advantageously arranged in a row running parallel to the rim of the sensor array. This facilitates making contact with the conductor tracks accommodated on the carrier.

According to a particularly advantageous refinement, the second contact elements may be a constituent of an integrated component that is provided on an underside of the sensor array opposite the top side. The integrated component can be an electronic evaluation system with the aid of which, for example, the signals supplied by the sensor array are digitized.

According to a refinement of an embodiment of the invention, the carrier may be in the form of a clamp of U-shaped cross section. The form of the clamp may be preferably adapted in this case to the form, for example, the thickness, of the sensor array. It thereby may be possible in a simple way to make contact between the first and second contact elements. The clamp can be plugged onto the edge of the sensor array, and contact can subsequently be made by adhesive, soldering or welding method.

According to a further refinement, the carrier may have a thickness in the range from 2 μm to 70 μm, and the insulation may have a thickness in the range from 2 μm to 70 μm. The thickness of the film can be in the range from 5 μm to 50 μm. It is thereby possible to reduce and even minimize the interspace between sensor modules arranged next to one another at the edge. It can be achieved as a result that a sensor array formed from sensor modules has a highest possible image quality. The carrier is preferably produced from a plastic such as, for example, polyimide or Kapton, or from epoxy resin. The insulation can be produced from a flexible, epoxy-resin-based solder resist or from polyimide. The electrically insulating material of the film is expediently produced from Kapton.

According to a particularly advantageous refinement of the invention, the conductor tracks may be produced from Cu. The conductor tracks can be applied to the carrier with the aid of any desired method, known from the prior art, for applying conductor tracks to a carrier material. The first and the second contact elements may be preferably connected to the conductor tracks by a soldered contact, adhesive contact or welded contact. Furthermore, the conductor tracks or the first and second contact elements can have a contact surface coated with NiAu. Surfaces coated in such a way are particularly well suited for producing a soldered, adhesive or welded contact.

According to a further refinement, the width of the carrier may correspond approximately to a width of the sensor array. This particularly facilitates making contact with the aid of first contact elements provided over substantially the entire width of the sensor array.

The first contact elements, in one embodiment, advantageously may be provided at two edges of the sensor array which have a common corner, and the conductor tracks may be routed around the rims corresponding to the respective edge in order to connect to the second contact elements. The sensor arrays may be expediently arranged such that only one carrier or one film is passed through between their rims. The sensor arrays can thereby be arranged next to one another with only a very slight interspace. The arrangement can be made, for example, in the manner of a chessboard pattern. This permits the sensor arrays to make contact in a simple way.

According to a further measure of an embodiment of the invention, a detector is provided that includes a plurality of the detector modules according to the invention.

### BRIEF DESCRIPTION OF THE DRAWINGS

An exemplary embodiment of the invention is explained below in more detail with the aid of the drawings, in which:

FIG. 1 shows a plan view of a sensor array,

FIG. 2 shows a plan view of a sensor array with films fitted thereon at the edge,

FIG. 3 shows a sectional view in accordance with the line of section A-A in FIG. 2,

FIG. 4 shows a plan view of a section of a detector module,

FIGS. 5A, B show contact-making via a carrier formed as a clamp with a U-shaped cross section, and

FIGS. 6A, B show contact-making via a carrier of planar form.

### DETAILED DESCRIPTION OF THE EXEMPLARY EMBODIMENTS

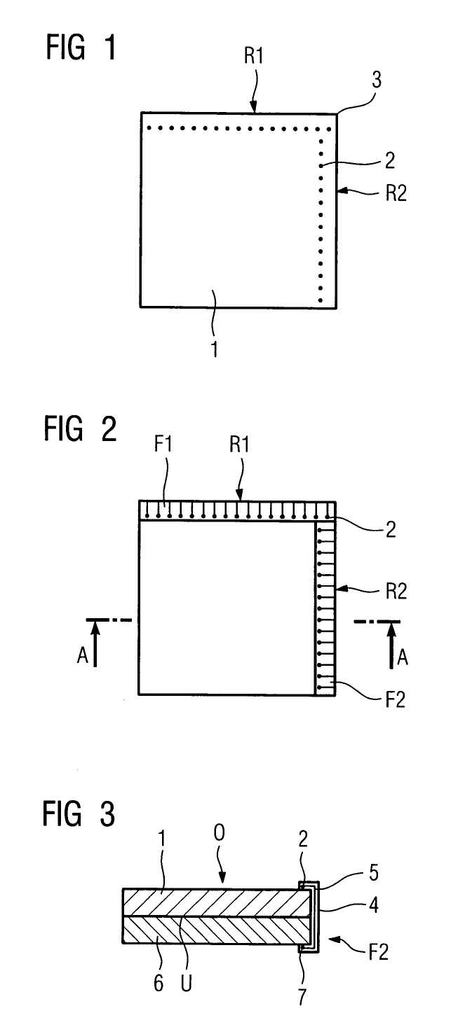

A sensor array 1 is shown schematically in plan view in FIGS. 1 and 2. On its top side O, the sensor array 1 has first contact elements 2 at two neighboring edges R1, R2. The two edges R1, R2 have a common corner 3.

FIG. 2 shows the sensor array 1 illustrated in FIG. 1, films F1, F2 being fitted thereon in the edge regions. As may be best be seen from FIG. 3, the films F1, F2 include layers 4 that are situated one above another and are produced from an electrically insulating plastic, for example Kapton. Conductor tracks 5 produced from Cu are embedded in a parallel arrangement between the electrically insulating layers 4. Each of the conductor track 5 is respectively connected to one of the first contact elements 2. Provided on an underside U of the sensor array 1 opposite the top side O is an integrated component 6 that has second contact elements 7 corresponding to the first contact elements 2. The integrated component 6 can be, for example, a chip, ASICS or the like. Each conductor track 5 connected to a first contact element 2 is connected to a second contact element 7 corresponding thereto.

As may be seen from FIG. 2, the films F1, F2 extend substantially over the entire width of the sensor array 1. Optimum use is made in this way of the space available for making contact with the sensor array 1.

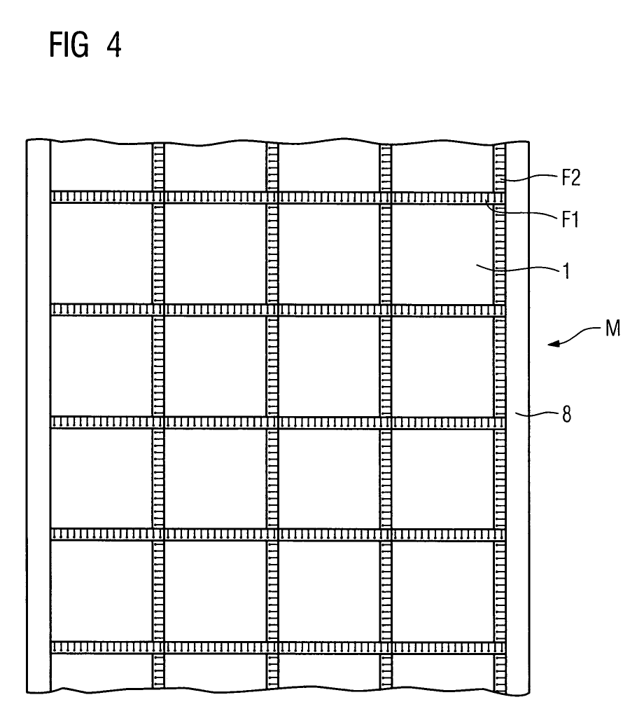

FIG. 4 shows a schematic plan view of the arrangement of contacted sensor arrays 1 on a printed circuit board 8 of a detector module denoted in general by the reference symbol M. The sensor arrays 1 are arranged like a chessboard. The sensor arrays 1 can be arranged next to one another only by interposing a foil F1, F2 in each case, because the films F1, F2 are respectively arranged at two neighboring edges R1, R2. The films F1, F2 can be conventional films in which conductor tracks 5 are embedded. Such films F1, F2 can be produced in a thickness from 5 to 50 μm. By using such films F1, F2, it is possible for the sensor arrays 1 on the printed circuit board 8 to be arranged next to one another at a slight spacing that is substantially given by the thickness of the film F1, F2.

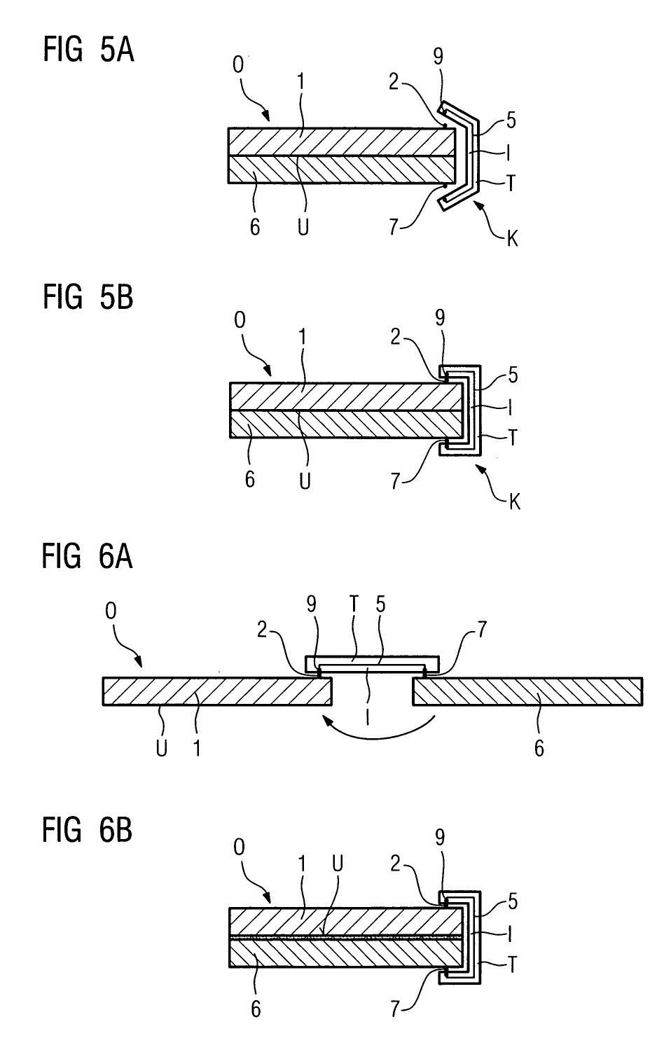

Contact-making via a carrier in the form of a clamp of U-shaped cross section is shown schematically in FIG. 5A and FIG. 5B. First contact elements 2 are fitted on the top side O of the sensor array 1. Second contact elements 7 are fitted on the integrated component 6 fitted on the underside U. The reference symbol K denotes a clamp of U-shaped cross section. The clamp K includes a carrier T on which conductor tracks 5 are accommodated. The conductor tracks 5 are covered by an insulation I. Contact surfaces of the conductor track 5 that are not covered by the insulation I are denoted by the reference numeral 9.

In FIG. 5A, the clamp K is plugged onto the edge of the sensor array 1 and onto the integrated component 6, the form of the clamp K corresponding substantially to its form on the rim side. The contact surfaces 9 of the conductor track 5, which is 10 μm to 30 μm thick for example, are coated with NiAu such that contact may be made with the contact surfaces 9 by soldering, welding or a conducting adhesive. The contact surfaces 9 and the first contact elements 2 and second contact elements 7 are brought together by final shaping of the clamp K. As illustrated in FIG. 5B, the first contact elements 2 and second contact elements 7 are connected to one another in an electrically conducting fashion by a soldered, welded or adhesive connection.

FIGS. 6A and B illustrate schematically alternative contact-making via a carrier T of planar form. The sensor array 1 and the integrated component 6 are arranged next to one another in a plane. Both the first contact elements 2 and the second contact elements 7 are accessible from above.

In order to make contact, the carrier T is applied to the sensor array 1 and the integrated component 6 in such a way that the contact surfaces 9 of the conductor tracks 5 lie on the first contact elements 2 and second contact elements 7. An electrically conducting, fixed contact is produced by a soldered, adhesive or welded connection.

As illustrated in FIG. 6B, the integrated component 6 is subsequently fitted on the underside U of the sensor array 1 by an adhesive. In this arrangement, the flexible carrier T adapts to the form of the rims such that the carrier T with the conductor tracks 5 bears closely against the rim surfaces of the sensor array 1 and of the integrated component 6.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A detector module for an X-ray computer tomograph, comprising:
a number of sensor arrays, provided next to one another on a printed circuit board, each of the sensor arrays including a plurality of first contact elements on a top side averted from the printed circuit board, wherein the first contact elements are connected in an electrically conducting fashion to second contact elements via conductor tracks that are at least one of accommodated in and on an electrically insulating, flexible carrier.

2. The detector module as claimed in claim 1, wherein the conductor tracks accommodated on the carrier are covered by an insulation.

3. The detector module as claimed in claim 1, wherein the first contact elements are provided at the edge of the sensor array.

4. The detector module as claimed in claim 1, wherein the second contact elements are provided on an underside, opposite the top side.

5. The detector module as claimed in claim 1, wherein at least one of the first contact elements and the second contact elements are arranged in a row running parallel to the rim of the sensor array.

6. The detector module as claimed in claim 1, wherein the second contact elements are a constituent of an integrated component provided on an underside of the sensor array, opposite the top side.

7. The detector module as claimed in claim 1, wherein the carrier is in the form of a clamp of U-shaped cross section.

8. The detector module as claimed in claim 1, wherein the carrier has a thickness in the range from 2 μm to 70 μm.

9. The detector module as claimed in claim 1, wherein the insulation has a thickness in the range from 2 μm to 70 μm.

10. The detector module as claimed in claim 1, wherein the carrier is produced from at least one of polyimide, Kapton and epoxy resin.

11. The detector module as claimed in claim 1, wherein the insulation is produced from a at least one of flexible, epoxy-resin-based solder resist, polyimide and Kapton.

12. The detector module as claimed in claim 1, wherein the conductor tracks are produced from Cu.

13. The detector module as claimed in claim 1, wherein at least one of the first contact elements and second contact elements are connected to the conductor tracks by at least one of a soldered contact, adhesive contact and welded contact.

14. The detector module as claimed in claim 1, wherein at least one of the conductor tracks, the first contact elements and second contact elements have a contact surface coated with NiAu.

15. The detector module as claimed in claim 1, wherein a width of the carrier corresponds approximately to a width of the sensor array.

16. The detector module as claimed in claim 1, wherein the first contact elements are provided at two edges of the sensor array which have a common corner, and the conductor tracks are routed around the rims corresponding to the respective edge in order to connect to the second contact elements.

17. The detector module as claimed in claim 1, wherein the sensor arrays are arranged such that only one carrier is passed through between their rims.

18. A detector comprising a plurality of the detector modules as claimed in claim 1.

19. A sensor array, comprising:
a plurality of first contact elements; and
conductor tracks, wherein the first contact elements are electrically connected to second contact elements via the conductor tracks, and wherein the conductor tracks are at least one of accommodated in and on an electrically insulating, flexible carrier.

20. A detector module comprising a plurality of sensor arrays as claimed in claim 19, arranged next to one another on a printed circuit board.

21. A detector comprising a plurality of the detector modules as claimed in claim 20.
